(19) United States
(12) Patent Application Publication
(10) Pub. No.: US 2026/0113224 A1
(43) Pub. Date: Apr. 23, 2026

(54) METHODS AND APPARATUS OF COMMUNICATING IN A PHYSICAL CODING SUBLAYER

(71) Applicant: Telefonaktiebolaget LM Ericsson (publ), Stockholm (SE)

(72) Inventors: Sergio MOSTI, Genova (IT); Paolo DEBENEDETTI, Genova (IT); Tomas THYNI, Stockholm (SE); Stefano ORSI, Genova (IT)

(73) Assignee: Telefonaktiebolaget LM Ericsson (publ), Stockholm (SE)

(21) Appl. No.: 19/115,865

(22) PCT Filed: Sep. 28, 2022
(86) PCT No.: PCT/EP2022/076963

§ 371 Date: Mar. 27, 2025

(51) Int. Cl. H04L 25/49

(52) U.S. Cl. CPC H04L 25/4906

(57) ABSTRACT

A method in a transmitter of a communications system, the transmitter comprising a physical coding sublayer, PCS, for transmitting data to a receiver, the method comprising: monitoring a digital data stream to identify PCS idle blocks in the digital data stream; generating substitute data blocks for transmitting to the receiver in place of the PCS idle blocks, the substitute data blocks comprising low transition blocks, LTBs, and one or more pattern information blocks.

### TECHNICAL FIELD

Embodiments of the present disclosure relate to methods and apparatus for communicating data in a physical coding sublayer (PCS) of a communications system, and in particular improving the efficiency with which data is transmitted in the PCS.

### BACKGROUND

5G fronthaul transport networks comprise millions of evolved Common Public Radio Interface (eCPRI) links which connect baseband units to their respective radio units via short and long Ethernet connections (e.g. grey Ethernet connections and/or Wavelength Division Multiplexing (WDM) Ethernet connections), which may consume up to 5 Watts (W) each (2.5 W max per transmitter/receiver side).

Energy Efficiency is an important requirement for next generation transport networks supporting 5G and future 6G mobile networks. This is because the number of nodes and users is expected to grow together with the densification of networks and the bandwidth demands of subscribers and sensors.

For smaller nodes even a few Watts of energy saving may imply huge savings at network level, considering there may be many devices connected.

Energy saving has environmental benefits and also reduces the power supply demand from telecommunications operators, which may be a large fraction of the overall network operational costs.

Typical methods for improving the efficiency of Ethernet links involve reducing the power consumption of physical layer devices (PHYs) during periods of low link utilisation. In such methods, when controlling software or firmware decides that no data needs to be sent, it can issue a low-power idle (LPI) request to the Ethernet controller physical layer (PHY).

Such methods may not be applicable for Radio Access Network (RAN) (and near RAN) applications, because it is desirable that RAN (and near RAN) links are always established in order to exchange control and data packets (even when the throughput is low due to traffic demand patterns).

Typical power saving methods introduced in Ethernet network do not consider the requirements imposed by 5G technology, in terms of link availability, synchronisation and latency.

Power saving in Ethernet nodes may also be achieved by using idle messages to power down unused transport links. This method may be used with Ethernet nodes used for broadband services, where some links are over-dimensioned with respect to the subscriber usage. This method does not take into consideration the traffic patterns generated by a baseband or radio unit.

Typical fronthaul traffic patterns may include burst traffic interleaved with silent periods repeating every Transmission Time Interval (TTI) period (e.g. 1 millisecond (ms) periods for 5G Mobile Broadband services and 125 microseconds (us) periods for 5G ultra-reliable low latency communications (URLLC) services).

Such patterns may not be compressed for optimisation at the RAN layer since they correspond to actual timeslots carrying in-phase and quadrature (I/Q) samples further translated via Fast Fourier Transform (FFT) conversion. In case of Time Division Duplex (TDD) used in 4G and 5G RAN, at least 50% of transmission blocks (e.g. PCS blocks) may be blank in the downlink direction and/or the uplink direction, since transmission is “half duplex”.

Furthermore, the eCPRI use of fronthaul depends on actual cell load in uplink and downlink and the ratio depends on the TDD pattern used. In the case of optical transmission, the optics on the baseband unit side may be transmitting data for up to 65% of time, while the uplink radio unit interface may be transmitting for less than 30% of time—and their relevant traffic load.

Fronthaul links may be dedicated to RAN connection thereby preventing the use of idle periods to carry additional traffic, as might occur in fixed broadband services. That is, the strict latency and synchronisation requirements of RAN networks, as well as the nature of fronthaul links that are always up at full capacity to keep radio units connected to their baseband units over dedicated links (e.g. to a baseband unit or a dedicated link to a switch-router aggregating multiple radios), may prevent transmission of data during idle periods.

It will be understood that improvements in network efficiency is desirable, for example in a fronthaul network.

### SUMMARY

It is an object of the present disclosure to provide methods and apparatus for efficiently transmitting and receiving data in a PCS of a communications system.

Aspects of embodiments provide transmitter control circuitry, a transmitter, a receiver, methods and computer programs which at least partially address one or more of the challenges discussed above.

A first aspect of the disclosure provides a method in a transmitter of a communications system, the transmitter comprising a physical coding sublayer, PCS, for transmitting data to a receiver. The method comprises monitoring a digital data stream to identify PCS idle blocks in the digital data stream. The method further comprises generating substitute data blocks for transmitting to the receiver in place of the PCS idle blocks, the substitute data blocks comprising low transition blocks, LTBs. In some examples, the substitute data blocks further comprise one or more pattern information blocks.

By transmitting the PCS user data blocks with the substitute data blocks, instead of the PCS idle blocks, transmitter power consumption may be reduced.

Optionally, the LTBs comprise one or more first type LTBs comprising a series of digital bits having zero transitions between binary states.

The first type LTBs are configured for low-power transmission. That is, due to the lack of transitions between binary states, the transmitter is not required to transition between on and off states during transmission of the first type LTBs, thereby reducing power consumption

A second aspect of the disclosure provides a transmitter control circuitry of a transmitter in a communications system. The transmitter comprises a physical coding sublayer, PCS, of a transmitter in a communications system for transmitting data to a receiver. The transmitter control circuitry comprises processing circuitry and a non-transitory machine-readable medium storing instructions. The transmitter control circuitry is configured to monitor a digital data stream to identify PCS idle blocks in the digital data stream. The transmitter control circuitry is further configured to generate substitute data blocks for transmitting to the receiver in place of the PCS idle blocks, the substitute data blocks comprising low transition blocks, LTBs. In some examples, the substitute data blocks further comprise one or more pattern information blocks.

A third aspect of the disclosure provides a transmitter comprising the transmitter control circuitry in accordance with the second aspect.

A fourth aspect of the disclosure provides a computer-readable medium comprising instructions which, when executed on a computer, cause the computer to perform a method in accordance with the first aspect.

A fifth aspect of the disclosure provides a method in a physical coding sublayer, PCS, of a communications system of receiving data from a transmitter. The method comprises monitoring a digital data stream transmitted from a transmitter to identify one or more pattern information blocks comprising information about PCS idle blocks. The method further comprises generating recovered data blocks comprising PCS idle blocks based on the information in the one or more pattern information blocks.

A sixth aspect of the disclosure provides a receiver configured to perform the method in accordance with the fifth aspect.

A seventh aspect of the disclosure provides a computer-readable medium comprising instructions which, when executed on a computer, cause the computer to perform a method in accordance with the fifth aspect.

Further aspects provide apparatuses and computer-readable media comprising instructions for performing the methods set out above, which may provide equivalent benefits to those set out above.

### BRIEF DESCRIPTION OF DRAWINGS

For a better understanding of the present disclosure, and to show how it may be put into effect, reference will now be made, by way of example only, to the accompanying drawings, in which:

FIG. 1 is a flow chart illustrating a method of communicating in a PCS;

FIG. 2A is a schematic block diagram of transmitter control circuitry;

FIG. 2B is another schematic diagram of transmitter control circuitry;

FIG. 3A is a schematic block diagram of a receiver;

FIG. 3B is another schematic block diagram of a receiver;

FIG. 4 is a schematic diagram of a communications system;

FIG. 5 is a schematic diagram illustrating the digital buffer line and a low transition encoder/decoder (LTED);

FIG. 6 is a schematic diagram of PCS blocks;

FIG. 7 is a schematic diagram of transmitter circuitry;

FIG. 8 is a schematic diagram of receiver circuitry; and

FIG. 9 illustrates alternative embodiments of the method of communicating in a PCS.

### DETAILED DESCRIPTION

The following sets forth specific details, such as particular embodiments for purposes of explanation and not limitation. It will be appreciated by one skilled in the art that other embodiments may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Embodiments of the present disclosure provide methods and apparatus for efficiently transmitting and receiving data using a PCS of a communication system.

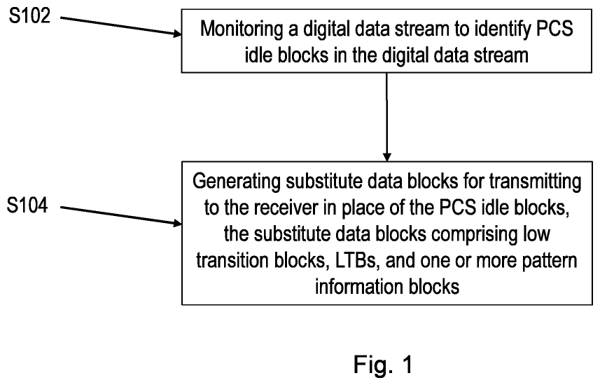

FIG. 1 is a flowchart illustrating a method in a transmitter of a communications system. In particular, the method is performed in a transmitter comprising a PCS for transmitting data to a receiver. The communications system may be a network communications system or a point-to-point communications system. The communications system may be, for example, an optical link or a microwave link. The communications system may be a fronthaul link of a radio access network.

The PCS may be the top sublayer of a physical layer of the communication system. Furthermore, the PCS may provide an interface between a physical medium attachment (PMA) sublayer of the communications system and a media-independent interface (MII) of the communications system. References to PCS may alternatively be referred to as the physical layer.

In certain embodiments, the PCS may be a networking protocol sublayer for Ethernet (e.g. according to the Fast Ethernet, Gigabit Ethernet, and 10 Gigabit Ethernet standards) or FlexEthernet. It may be responsible for data encoding and decoding, scrambling and descrambling, alignment marker insertion and removal, block and symbol redistribution, and lane block synchronization and de-skew.

In some embodiments, the communications system may use an enhanced common public radio interface (eCPRI) protocol.

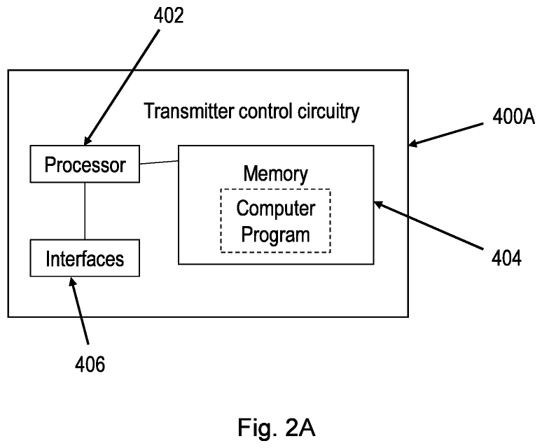

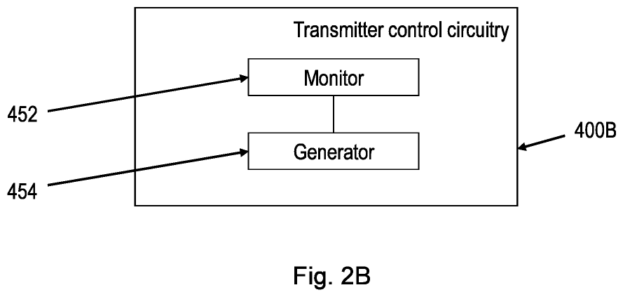

FIGS. 2A and 2B show transmitter control circuitry 400A, 400B in accordance with certain embodiments. The transmitter control circuitry 400A, 400B may perform the method of FIG. 1.

It will be understood that the transmitter control circuitry 400A, 400B may be incorporated within a transmitter in order that the transmitter may perform the method of FIG. 1. The transmitter may be a transceiver configured to transmit data and receive data in the communications system.

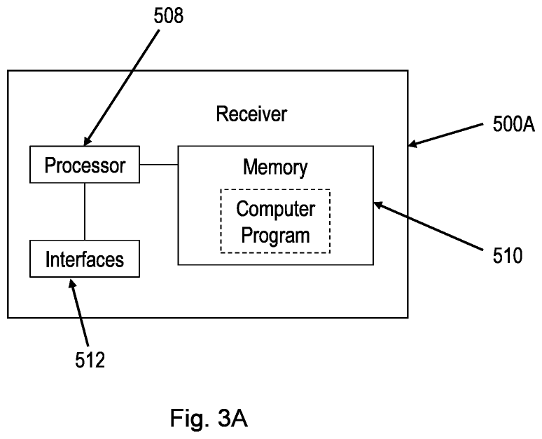

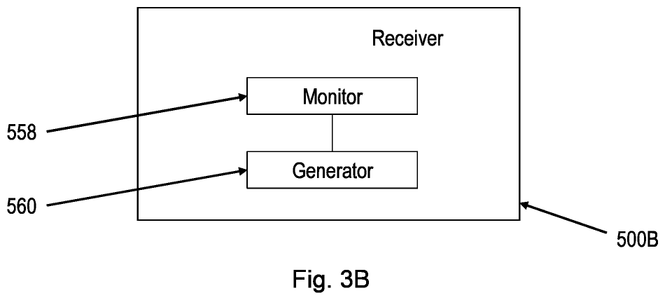

FIGS. 3A and 3B show receivers 500A, 500B in accordance with certain embodiments. The receivers 500A, 500B may receive data from the transmitter control circuitry 400A, 400B. The receivers may be transceivers configured to transmit data and receive data in the communications system. In embodiments where the receivers 500A, 500B are transceivers, they may be configured to transmit data by performing the method of FIG. 1.

The transmitter control circuitry 400A, 400B and the receivers 500A, 500B may be part of a communications system, such as the communications system discussed above. The transmitter control circuitry 400A, 400B and the receivers 500A, 500B may be configured to communicate with each other by transmitting and receiving data, respectively, within the communications system.

It will be understood that the transmitting steps discussed below with reference to the method of FIG. 1 may be performed by the transmitter control circuitry 400A, 400B, a transmitter comprising the transmitter control circuitry 400A, 400B and/or a transceiver comprising the transmitter control circuitry 400A, 400B. For ease of explanation, the following steps will be described with reference to the transmitter control circuitry 400A, 400B.

In step S102, a digital data stream is monitored to identify PCS idle blocks (or LPI blocks) in the digital data stream. Monitoring the digital data stream may be performed, for example, by the processor 402 of the transmitter control circuitry 400A running a program stored on the memory 404 in conjunction with the interfaces 406, or may be performed by a monitor 452 of the transmitter control circuitry 400B.

The digital data stream may comprise a stream of PCS blocks comprising at least PCS idle blocks and PCS user data blocks.

A PCS block may be understood to be a block of data formatted for transmission and reception in the PCS of the communication system. The block of data in each PCS block may comprise a series of digital bits each having a binary state of one or zero. Data may be encoded in each PCS block as values of binary or digital bits. In a sequence of digital bits, there will be transitions between binary values i.e. a transition from 0 to 1 or from 1 to 0. For example, the bit sequence 010101 has five transitions.

The PCS idle blocks may comprise a series of digital bits each having a binary state of one or zero. The series of digital bits of the PCS idle blocks may initially be predefined according to the IEEE 802.3 standard. A scrambler may be used to scramble the series of digital bits of the PCS idle blocks such that the PCS idle blocks comprise a header with a code type standing for idle (e.g. binary bits 1 and 0) followed by a group of scrambled bits (e.g. predefined bits). That is, the series of digital bits of PCS idle blocks may include a group of scrambled bits which do not provide any useful (user) data. The transitions between binary states in the PCS idle blocks may not be associated with useful data. The scrambler may be an XOR function configured to ensure the group of scrambles bits include transitions between binary states (i.e. the scrambled bits are not all 0 or all 1).

For ease of explanation, from hereon the term “PCS idle blocks” will be used to describe PCS blocks comprising bits which do not comprise useful data. The term “PCS user data blocks” will be used to describe PCS blocks comprising user data encoded as values of bits, or transitions between binary states of the digital bits.

The monitoring may be performed by the transmitter control circuitry 400A, 400B by buffering the digital data stream. That is, the transmitter control circuitry 400A, 400B may buffer the digital data stream such that PCS blocks are processed before being transmitted, thereby effectively delaying transmission of the digital data stream. In some aspects, the buffering is carried out by the physical layer of the transmitter. The processing that takes place during the buffering may comprise identifying one or more PCS idle blocks, i.e. sequences of digital bits in the digital data stream having a predetermined pattern of binary values that identify a PCS idle block. The predetermined pattern may be a predetermined pattern of transitions between binary values of digital bits in a buffered PCS block which indicate the buffered PCS block is a PCS idle block (or a LPI block). For example, the predetermined pattern may be 01111000.

The PCS idle blocks may be recognisable through encoding according to standards, e.g. “TS 802.3 Standard for Ethernet” by the Institute of Electrical and Electronic Engineers (IEEE), available at https://standards.ieee.org/ieee/802.3/7071/ as of 4 Aug. 2022.

Monitoring the digital data stream may comprise identifying PCS idle blocks. In some aspects, the monitoring comprises identifying a predetermined number of PCS idle blocks as a group of idle blocks. In some embodiments, the predetermined number of PCS idle blocks are adjacent PCS blocks thereby forming the group of idle blocks (i.e. a series of adjacent PCS idle blocks without any PCS user data blocks between the adjacent PCS idle blocks).

The predetermined number of PCS idle blocks may be set according to the requirements of the communications system. Furthermore, the predetermined number may be adjusted according to changes in the communications system. The predetermined number may be, for example, 2, 5, 10 or 20.

In some embodiments, plural groups of idle blocks each comprising the predetermined number of PCS idle blocks may be identified. That is, the buffered digital data stream may be continuously monitored in order to identity separate groups of idle blocks which are separated by at least one PCS user data block.

As discussed above, the predetermined number of PCS idle blocks may be adjusted to increase or decrease the frequency with which group of idle blocks are identified. For example, in embodiments where the predetermined number is set to 2, the likelihood of identifying two adjacent PCS blocks is increased, and therefore the frequency with which groups of idle blocks are identified increased. Conversely, in embodiments where the predetermined number is set to a higher number, e.g. 20, the likelihood of identifying twenty adjacent PCS blocks is relatively low thereby reducing the frequency with which groups of idle blocks are identified.

In step S104, substitute data blocks are generated for transmitting to the receiver 500A, 500B in place of the PCS idle blocks. The substitute data blocks comprising low transition blocks (LTBs) and one or more pattern information blocks. Generating the substitute data blocks may be performed, for example, by the processor 402 of the transmitter control circuitry 400A running a program stored on the memory 404 in conjunction with the interfaces 406, or may be performed by a generator 454 of the transmitter control circuitry 400B. In some examples, the substitute, or LTB, blocks replacing the PCS idle blocks avoid the conventional scrambling process. Thus, the substitute blocks do not undergo a scrambling process which might introduce transitions and/or bits with a value of 1. Blocks which are not replaced, e.g. blocks containing user data, control data, or idle blocks which do not trigger a replacement, have their bit values scrambled by a scrambler prior to transmission.

In some examples, the identified PCS idle blocks may be Low-Power Idle (LPI) blocks and the substitute data blocks are transmitted to the receiver 500A, 500B in place of the LPI blocks.

A substitute data block may be understood to be a block of data formatted for transmission and reception in the PCS of the communication system. A substitute data block, also referred to as a substitute block, may be either an LTB block or a pattern information block.

LTBs may be PCS blocks having sequences of digital bits with fewer transitions between binary states compared to PCS idle blocks and PCS user data blocks. As such, the physical layer LTBs require less power to transmit. Alternatively or in addition, the LTB may comprise all, or a majority, of bits with a zero value. The zero bit value corresponds to a transmitter (e.g. laser) being switched off.

The block of data in each LTB may comprise a series of digital bits each having a binary state of one and/or zero. The substitute data blocks may comprise two types of LTB blocks. In some examples, at least one first type LTB block and at least one second type LTB, are transmitted in a sequence, as discussed below:

First type LTBs may comprise a series of digital bits having zero transitions between binary states. That is, the series of digital bits in first type LTBs may all have the same binary value (i.e. one or zero) such that zero transitions between binary states are included in first type LTBs. The first type LTBs are configured for low-power transmission. That is, due to the lack of transitions between binary states, the transmitter is not required to transition between on and off states during transmission of the first type LTBs, thereby reducing power consumption. For example, the substitute data block, i.e. LTB of a first type, comprises only zero value bit values. This block, in the PCS, causes the transmitter (e.g. laser) to switch off for the duration of the block.

Second type LTBs may comprise a series of digital bits having transitions between binary states as a synchronisation signal. That is, the second type LTBs may comprise a series of digital bits having a limited number of transitions between binary states (i.e. fewer transitions between binary states compared to PCS idle blocks and PCS user data blocks), where the limited number of transitions are used for encoding synchronisation information as a synchronisation signal.

The synchronisation signal may comprise timing information for synchronisation transmission timing between the transmitter control circuitry 400A, 400B and the receiver 500A, 500B.

In some embodiments, at least half of the digital bits of the one or more second LTBs have zero transitions. The remaining half of digital bits may comprise the synchronisation information in the form of transitions between ones and zeros of the digital bits. Alternatively, the ratio of zero transitions to synchronisation information may be 25:75, 75:25, 10:90 or 90:10, for example.

A pattern information block may comprise information about the PCS idle blocks. In some embodiments, a pattern information block may comprise information indicating a quantity of PCS idle blocks in the original bitstream, and which have not been transmitted. As such, the information is the number of PCS idle blocks in the original stream to be transmitted. The quantity of PCS idle blocks may be the quantity of PCS idle blocks identified during the monitoring (i.e. the quantity of PCS idle blocks that should be generated by the receiver 500A, 500B). For example, if five PCS idle blocks are identified during the monitoring, the pattern information block may comprise a series of digital bits having information (e.g. bits or transitions) between binary states which encode information indicating that five PCS idle blocks were identified by the transmitter control circuitry 400A, 400B. In embodiments where the monitoring comprises identifying a predetermined number of PCS idle blocks as a group of idle blocks, the pattern information block may comprise information indicating that a group of idle blocks has been identified. Thus, the indication of the number of idle blocks provides for the receiver to regenerate the PCS idle blocks in the corresponding Physical layer (e.g. PCS layer) of the receiver.

In embodiments where the monitoring identifies plural groups of idle blocks, each comprising the predetermined number of PCS idle blocks, a pattern information block may encode a number of identified groups of idle blocks (or number of idle blocks) as information in the one or more pattern information blocks. For example, if the monitoring identifies four groups of idle blocks, the pattern information block may encode information indicating four groups of idle blocks have been identified.

In certain embodiments, the substitute data blocks may comprise a plurality of pattern information blocks, each pattern information block comprising information about the PCS idle blocks. Each of the plural pattern information blocks may comprise substantially the same information about the PCS idle blocks as discussed above. Providing plural pattern information blocks comprising substantially the same information about the PCS idle blocks improves the redundancy of transmission data in a PCS.

The transmitter control circuitry 400A, 400B may be configured to transmit the substitute data blocks to the receiver in place of the PCS idle blocks. Transmitting the substitute data blocks in place of the PCS idle blocks may comprise replacing the buffered PCS idle blocks with the substitute data blocks and transmitting the substitute data blocks in place of the buffered PCS idle blocks. For example, the substitute data blocks may be multiplexed with PCS user data blocks and transmitted with the PCS user data blocks as a low-power digital data stream.

Transmitting the substitute data blocks in place of the PCS idle blocks may comprise replacing the buffered PCS idle blocks with the substitute data blocks and transmitting the substitute data blocks in place of the buffered PCS idle blocks. For example, the substitute data blocks may be multiplexed with PCS user data blocks and transmitted with the PCS user data blocks as a low-power digital data stream. The substitute data blocks may comprise at least one of: all zero bit values, no bit value transitions, majority of the bits being zero, synchronization transitions and information indicating the number of substitute blocks, for example, in blocks which are otherwise all zeros.

A duration of each substitute data block may be substantially or exactly the same as a duration of a PCS idle block. That is, the duration of a substitute data block (e.g. a pattern information block of a LTB block) may have the same duration as a corresponding PCS idle block which it replaces. By ensuring the same duration is maintained when the substitute data blocks are transmitted in place of the buffered PCS idle blocks, timing synchronisation is preserved. A duration of each substitute data block may be substantially the same as a duration of a single PCS idle block. The wording “substantially the same duration” may be taken to mean two blocks both having the same number of bits, i.e. binary values (and therefore take the same amount of time to be transmitted).

Transmitting PCS blocks may comprise switching a mode of the transmitter between a transmitting mode and a non-transmitting mode based on information in the substitute data blocks. The frequency at which the transmitter switches between the transmitting mode and the non-transmitting mode may depend on the number of transitions between binary values of the digital bits in the substitute data blocks. For example, the first type LTBs comprise a series of digital bits having zero transitions between binary states, and therefore the transmitter is not switched between modes for first LTBs. Second type LTBs and pattern information blocks include transitions between binary values which require the transmitter to switch between modes (i.e. switch on and off) in order to transmit the encoded information.

By transmitting the PCS user data blocks with the substitute data blocks, instead of the PCS idle blocks, transmitter power consumption may be reduced.

In embodiments where the monitoring comprises identifying a predetermined number of PCS idle blocks as a group of idle blocks, the substitute data blocks may comprise a group of LTBs and the one or more pattern information blocks. The group of LTBs may comprise the predetermined number of LTBs. For example, in embodiments where the predetermined number of PCS idle blocks is six, the group of LTBs comprises six LTBs.

In embodiments where plural groups of idle blocks are identified, the substitute data blocks may comprise a group of LTBs corresponding to each identified group of idle blocks.

The receiver 500A, 500B is configured to monitor a digital data stream transmitted from a transmitter to identify one or more pattern information blocks comprising information about PCS idle blocks. Monitoring the digital data stream may be performed, for example, by the processor 508 of the receiver 500A running a program stored on the memory 510 in conjunction with the interfaces 512, or may be performed by a monitor 558 of the transmitter control circuitry 500B.

The receiver may be informed by the pattern information blocks about the presence of the substitute data blocks. The pattern information block may be recognisable by the coding. The synchronisation field may contain a transition from one to zero (i.e. values “10”, as defined by IEEE 802.3 for control blocks.

The digital data stream may comprise substitute data blocks (comprising one or more first LTBs, one or more second LTBs and at least one pattern information block) and PCS user data blocks, as described above.

Upon identifying the one or more pattern information blocks, the receiver 500A, 500B generates recovered data blocks comprising PCS idle blocks based on the information in the one or more pattern information blocks (e.g. plural pattern information blocks each comprising information about the PCS idle blocks). Generating recovered data blocks may be performed, for example, by the processor 508 of the receiver 500A running a program stored on the memory 510 in conjunction with the interfaces 512, or may be performed by a generator 560 of the transmitter control circuitry 500B.

The recovered PCS idle blocks may be identical to the PCS idle blocks described above, which were replaced by substitute data blocks by the transmitter control circuitry 400A, 400B. The PCS idle blocks may be recovered by decoding the information provided by the pattern information block to determine how many PCS idle blocks should be generated. For example, if three PCS idle blocks were identified in the digital data stream at a transmitter side, three PCS idle blocks are generated by the receiver 500A, 500B. This allows layers above the physical layer to be unaware of the substitution carried out during the transmission. Thus, the substitution of the replacement of PCS idle blocks in the transmission is transparent at the receiver above the Physical layer (Layer 1), i.e. above the Physical Coding Sublayer.

As discussed above, the one or more pattern information blocks may comprise information indicating a quantity of PCS idle blocks. The information indicating a quantity of PCS idle blocks may be identified by the receiver 500A, 500B during the monitoring in order to generate the recovered data blocks.

The recovered data blocks may comprise groups of idle blocks comprising a predetermined number of PCS idle blocks. Further, the recovered data blocks may comprise plural groups of idle blocks each comprising a predetermined number of PCS idle blocks.

The receiver 500A, 500B may be further configured to identify a series of digital bits having transitions between binary states as a synchronisation signal and/or control information for controlling the receiver.

The synchronisation signal may be used by the receiver 500A, 500B to perform synchronisation transmission timing between the transmitter control circuitry 400A, 400B and the receiver 500A, 500B.

The control information may be used by the receiver 500A, 500B to transition between operating modes, as discussed above.

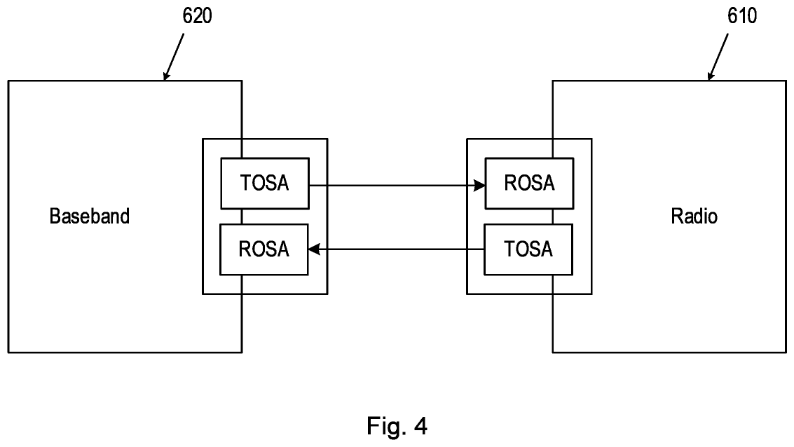

Embodiments of the method for communicating in a PCS of a communication system will now be described with reference to FIGS. 4, 5 and 6. In the following embodiments, the transmitter and the receiver are both transceivers comprising a Transmitter Optical Subassembly (TOSA) and a Receiver Optical Subassembly (ROSA).

FIG. 4 is a schematic diagram of the communication system comprising a radio unit 610 and a baseband 620. Both the radio 610 and the baseband may host grey or WDM optical modules for use in an optical fibre link.

The TOSAs convert electrical signals into optical signals (E/O conversion). The ROSAs convert optical signals into electrical signals (O/E conversion). The link between the radio 610 and the baseband 620 may be a dual or single fiber symmetric link. For example, the link may be an eCPRI link, e.g. having a low-level split 7.2 interface carrying I/Q samples with FFT translation into the frequency domain to compress data.

The eCPRI interface is bound to TTI of the RAN system with 1 ms periods. During each TTI period the eCPRI interface carries information bound to the actual radio 610 traffic. The baseband 620 and the radio 610 may use 64b/66b PCS blocks for 10 Giga bit rates and 25 Giga bit rates according to IEEE 802.3 The distance between the radio 610 and the baseband 620 may be relatively short (e.g. less than a few kilometers in Distributed Radio Access Network (DRAN) architectures, or may be up to e.g. 20 km in a Cloud Radio Access Network (CRAN) architectures. The RAN system may have a latency requirement, e.g. the latency may not exceed 100 μs.

In the communication system of FIG. 4, a digital buffer line (alternatively referred to as a digital delay line) is introduced which is fully symmetric on both sides of the link to detect patterns of idle PCS blocks prior to their transmission over the optical fiber link. As such, the identification and replacement of PCS idle blocks with blocks having fewer bit transitions, and hence lower transmission power requirements, may be carried out in both directions on a bi-directional link.

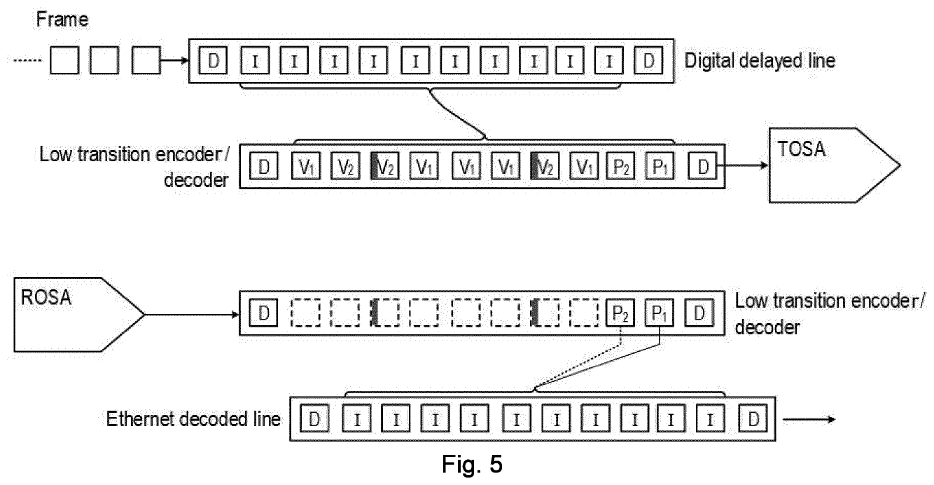

FIG. 5 is a schematic diagram illustrating the digital buffer line and a low transition encoder/decoder (LTED). The digital buffer line is connected to the LTED for transmission of the blocks by the TOSA, e.g. of the radio 610 or the baseband 620. The output of the LTED is received by the ROSA, e.g. of the other of the corresponding radio 610 or the baseband 620. The buffer line provides for a delay in which multiple PCS blocks can be monitored and identified together. For example, the buffer line allows for one or more idle PCS blocks to be identified and replaced. This is because a first PCS block is still in the buffer line when a second PCS block arrives in the buffer line, allowing for identification of the first PCS block as an idle block and/or a group of idle blocks, and subsequent replacement of the idle PCS block with a substitute block according to a described example. The digital delay line and LTED will now be discussed in more detail with reference to FIG. 5.

The digital buffer line buffers a set or frame of PCS blocks in order to identify idle PCS blocks. The digital buffer line introduces a predetermined delay equivalent to at least “M” idle PCS blocks. The idle PCS blocks (identified by “I” in FIG. 5) are replaced with an encoded low-power sequence, transmitted over the optical fiber link, and then reintroduced into a decoded line at the receiver side of the optical fiber link. Therefore, this method requires no changes to the PCS frames. It is noted that the method described with reference to FIGS. 4 to 6 may be used for transmission over Ethernet or microwave links.

PCS user data blocks are illustrated as blocks containing a “D” in FIG. 5.

The LTED is configured to replace identified PCS blocks (e.g. Idle PCS blocks) with one or more types of substitute PCS blocks. For example, one or more of the following substitute PCS block types:
Pattern information block (P1, P2, etc.) comprising information about a number of PCS idle blocks, e.g. indicating a length of the next idle pattern sequence with a redundancy mechanism.
Void block type 1 (e.g. the first type LTB discussed above) (V1), which is a block having all zero binary values.
Void block type 2 (e.g. the second type LTB discussed above) (V2), which is a block with all zero binary values apart from a limited set of 0-1 transitions in order to refresh the clock data recovery (CDR) synchronisation. The limited set of 0-1 transitions in a V2 block is illustrated by a small rectangle inside the V2 blocks.

In some examples, in order to provide redundancy, the LTED is configured to substitute a plurality of pattern information blocks comprising information about the number of Idle PCS blocks, e.g. the total number of idle PCS blocks or the number of Idle PCS blocks remaining in that group. In some examples, the pattern information blocks indicate a length of the next idle pattern sequence (i.e. P1, P2 . . . ). For example, each pattern information block is a 64b/66b PCS block which informs the ROSAs that a sequence of “M” idle PCS blocks is going to be replaced in the LTED.

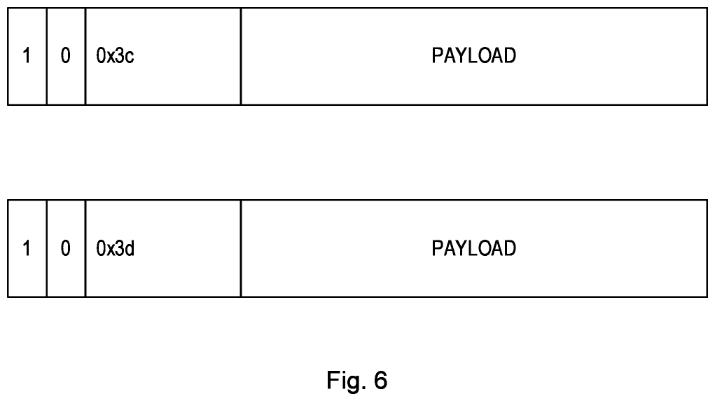

The actual number of pattern information blocks can be selected according to requirements of the system, e.g. according to the performance requirements of the CDR at the receiver or according to the characteristics of the signal. The structure of a pattern information block is illustrated in FIG. 6.

FIG. 6 is a schematic diagram of two pattern information blocks (e.g. P1 and P2, which for provide for redundancy against errors in detecting an idle pattern sequence at the ROSA). This is an example of use of one or more pattern information blocks, other examples are possible. In this example, both pattern information blocks in FIG. 6 comprise payload data.

The top pattern information block in FIG. 6 (e.g. P1) comprises payload which indicates to the receiver that there is a following sequence of “M-1” idle PCS blocks plus the current PCS block so the receiver can add “M” idle PCS blocks before passing the sequence from the Physical layer (PHY).

The bottom pattern information block in FIG. 6 (e.g. P2) comprises payload which indicates to the receiver that there is a following sequence of “M-n” idle PCS blocks plus “n” pattern-blocks. This provides an indication to the receiver to add “M-n” idle PCS blocks before passing the sequence from the PHY (previous pattern information blocks would be received as errors).

Therefore, each pattern information block defines an idle pattern sequence minus its position, so that even if a pattern information block is missed, the next pattern information blocks defines the remaining blocks in the pattern. Alternatively, a single pattern information block may be used, i.e. without the inclusion of a redundancy.

In some examples, the pattern information blocks comprise a synchronisation field comprising a transition from one to zero. This transition allows the receiver site to synchronize or hook to the block. The information blocks use an unused code type defined in IEEE 802.3 (e.g. 0x3C, 0x3D).

In some examples, the LTED inserts a plurality of void substitute blocks (V1 and V2), which are interleaved in the LTED to minimise transmission power usage as well as to secure CDR recovery on the receiving side. For example, the LTED is configured to insert substitute blocks which provide for a reduced number of transitions (to reduce power), and include a minimum number of transitions to maintain synchronization, e.g. 6 transitions every 256 bits.

The substitution of PCS idle blocks, e.g. using a digital buffer line, provides a means for the receiver (including the ROSA) to determine idle patterns. If the transmitted sequence is equal to a pre-defined threshold (e.g. “M”), the transmitter substitutes the idle PCS blocks in the LTED before transmission starts.

The pre-defined threshold above which idle PCS blocks are substituted may be optimised according to the signal type and the link performance. When the pre-defined threshold is set to be relatively high, the idle pattern sequences (e.g. the number of consecutive idle PCS blocks) would be relatively long thereby providing higher efficiency (due to a high ratio of pattern information blocks with respect to void blocks). When the pre-defined threshold is set to be relatively low, the idle pattern sequence would be relatively short thereby provide lower efficiency than a longer idle pattern sequence, but there would be a higher probability of a shorter idle pattern sequence occurring.

It will be understood that this method does not need a PHY controller or LPI client to start or end a low-power period since the delay line and the sequence replacement can be automated.

When implemented with Ethernet, it will be understood that this method is transparent from Ethernet protocol perspective since it is resolved within the physical layer transmission.

In summary, the examples (e.g. including a digital buffer line) is used to detect a sequence of idle PCS blocks and to transcode them with a low-power transmission sequence (i.e. using the LTED) encoded with the minimal number of 0-1 transmission required to maintain clock data recovery (CDR) on the receiving side.

Using the same encoding mechanism, the encoded sequence at the receiver (ROSA) is replaced with the original idle PCS blocks (i.e. the decoded line) allowing a restoration of the exact Ethernet signal (e.g. at Layer 2 or 3).

The digital delay line and the transcoding are simple and cost effective to be implemented and, additionally, they do not need any external control. The controller may only be required to set the threshold for idle sequence substitution, which thereby making this method power efficient.

By operating at the PCS, completely transparency is provided with respect to Ethernet (and RAN) interfaces, since the suppressed blocks are restored at destination. In particular, the restoration of the idle PCS blocks is carried out within the Physical layer (i.e. Layer 1, or PCS), and so is transparent to higher layers (e.g. Layer 2).

This method maximises power saving by implementing power saving at micro/nano-second level making this method suitable for TDD RAN applications.

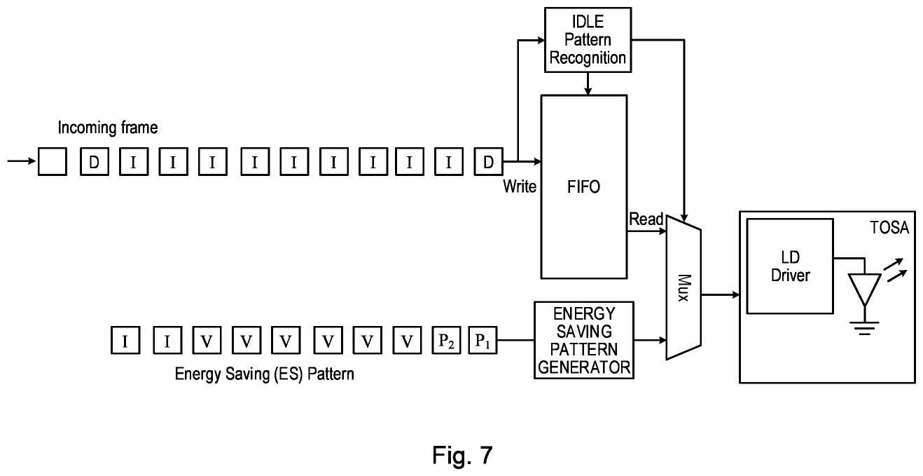

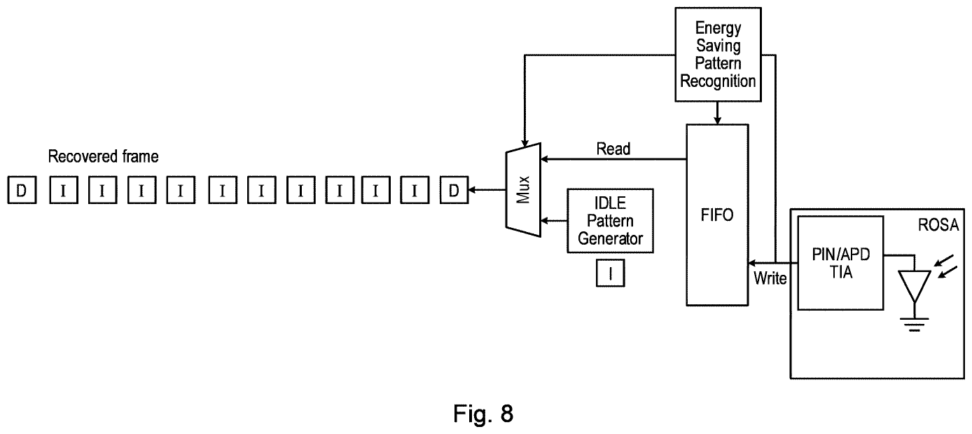

FIGS. 7 and 8 are schematic diagrams illustrating how the above described method may be implemented in hardware (e.g. in a main board (FPGA/ASIC), in an external PHY or in the transceiver itself).

FIG. 7 illustrates transmitter circuitry at a transmitter side. The transmitter circuitry comprises a multiplexer (MUX), a first-in first-out processor (FIFO), idle pattern recognition circuitry, and an energy saving pattern generator. The incoming frame signal is written inside the FIFO which represent the digital buffer line thereby allowing the idle pattern recognition circuitry to process the incoming frame signal. When the idle pattern recognition block recognises an idle pattern sequence from the incoming frame signal, it drives the MUX and the FIFO in order to substitute the idle PCS blocks with pattern information blocks and void blocks generated by the energy saving pattern generator to create the output of the LTED. The output of the LTED is sent to the TOSA of the transceiver to be converted to an optical signal and transmitted over the optical fiber. In some examples, the output of the transceiver matches the output of the LTED, e.g. the laser is turned on for a bit value of 1, and turned off for a value of 0, with a transition in between. The transceiver in the hardware of FIG. 7 is an optical transceiver comprising a laser diode (LD) and a LD driver. The optical transceiver may alternatively comprise a light emitting diode (LED) and a LED driver.

FIG. 8 illustrates receiver circuitry at a receiver side. The receiver circuitry comprises a MUX, a FIFO buffer, idle pattern generator, and an energy saving pattern recognition circuitry. At the receive side, the received optical signal is converted from an optical signal to an electrical signal by suitable detector, e.g. Positive, Intrinsic, Negative (PIN)/Avalanche Photo Diode (APD)/Trans Impedance Amplifier (TIA) circuitry. The recovered data is written inside the FIFO buffer which corresponds to the digital buffer line at the transceiver to allowing the energy saving pattern recognition circuitry to process the incoming signal over a period of time. When the energy saving pattern recognition circuitry recognises the substitute blocks, e.g. added in the LTED, the energy saving pattern recognition circuitry drives the idle pattern generator to generate the bit values for standard idle PCS blocks. The receiver circuitry, e.g. at the MUX, is configured to substitute the received bits (i.e. substitute blocks) in the FIFO buffer with a standard idle PCS blocks matching the originally replaced blocks. This recovered frame is then provided to users.

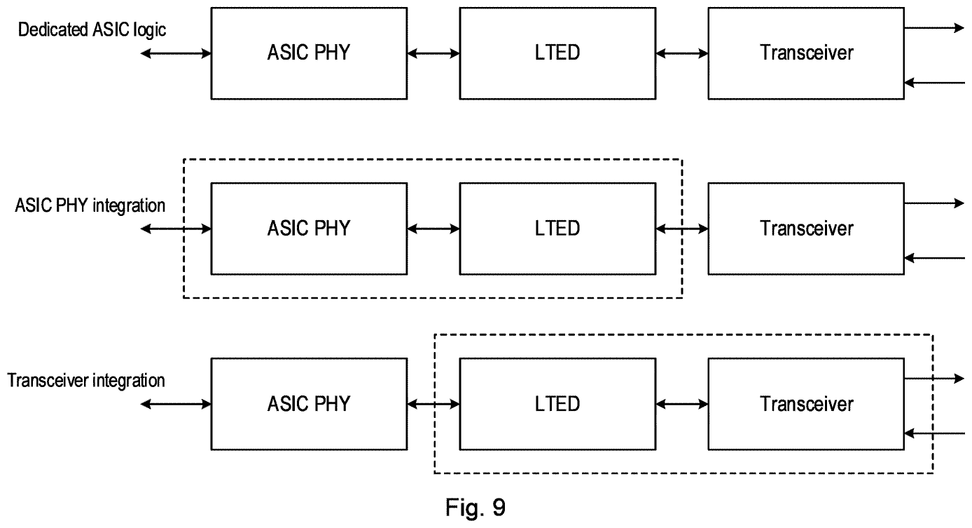

FIG. 9 is a schematic diagram illustrating different embodiments of apparatus for performing the method of any example. The apparatus for implementing the method may be considered as comprising a transceiver configured to transmit and receive the optical signals, and convert the optical signals to/from an electrical signal, e.g. as described for the TOSA and ROSA above. The apparatus may further comprise a function for encoding (and/or decoding) the bits received from higher layers to substitute PCS blocks, e.g. comprising the LTED. This substitution of PCS blocks is carried out by circuitry labelled as eCPRI Low Power Encoding, although it is not limited to eCPRI. The apparatus may further be considered as comprising processing circuitry (e.g. an ASIC) implementing the PCS sublayer, and optionally other physical layer processes (PHY). Such processing circuitry is labelled as ASIC PHY.

In a first example of the apparatus, the ASIC PHY, Low Power Encoding circuitry and transceiver are implemented as discrete circuitry and components. As such, these functions are implemented separately and connected together.

In a second example of the apparatus, the circuitry of the ASIC PHY, Low Power Encoding circuitry are integrated together. For example, a single processing circuitry or ASIC may be used for both functions.

In a third example, the Low Power Encoding circuitry is integrated with the transceiver, e.g. with the LD driver in the TOSA. The ASIC PHY is separate processing circuitry.

The energy efficiency of the PCS communication method may be calculated based on the number of void blocks (e.g. no or fewer bit transitions) that can be introduced in the transmitted signal, during which transmission is suppressed (e.g. a transmitter bias current can be suppressed during a void period). Reducing the number of transitions, and/or setting the laser diode to “off” for a zero bit value more frequently, reduces the power consumption of the transmitter (e.g. laser).

In some embodiments, the expected power saving due to transmitter current suppression can be estimated in general between 300 mW and 500 mW corresponding to 30-50% of the overall transceiver power supply.

The above discussed method also provides the advantage of reducing temperature of optical modules thereby increasing the operational range of outdoor radio even in challenging environmental conditions and reducing the need for air conditioning in central office applications.

It will be understood that the detailed examples outlined above are merely examples. According to embodiments herein, the steps may be presented in a different order to that described herein. Furthermore, additional steps may be incorporated in the method that are not explicitly recited above. For the avoidance of doubt, the scope of protection is defined by the claims.

1-35. (canceled)

36. A method in a transmitter of a communications system, the transmitter comprising a physical coding sublayer (PCS) for transmitting data to a receiver, the method comprising:
monitoring a digital data stream to identify PCS idle blocks in the digital data stream; and
generating substitute data blocks for transmitting to the receiver in place of the PCS idle blocks, the substitute data blocks comprising low transition blocks (LTBs).

37. The method of claim 36, wherein the LTBs are configured for low-power transmission and the substitute data blocks comprise one or more pattern information blocks, wherein the one or more pattern information blocks comprise information about the PCS idle blocks; and
the method further comprises:
transmitting the substitute data blocks to the receiver in place of the PCS idle blocks.

38. The method of claim 37, wherein
transmitting the pattern information blocks comprises switching a mode of the transmitter between a transmitting mode and a non-transmitting mode based on information in the substitute data blocks, and/or
the LTBs comprise one or more first type LTBs comprising a series of digital bits having zero transitions between binary states.

39. The method of claim 36, wherein the LTBs comprise one or more second type LTBs comprising a series of digital bits having one or more transitions between binary states as a synchronisation signal, and at least half of the digital bits of the one or more second LTBs have zero transitions.

40. The method of claim 36, wherein:
monitoring the digital data stream to identify PCS idle blocks comprises identifying a predetermined number of PCS idle blocks as a group of idle blocks, and the method comprises:
generating the substitute data blocks for transmitting to the receiver in place of the group of idle blocks, the substitute data blocks comprising a group of LTBs and the one or more pattern information blocks.

41. The method of claim 40, wherein monitoring the digital data stream comprises:
buffering the digital data stream,
replacing the buffered PCS idle blocks with substitute data blocks, and
transmitting the substitute data blocks in place of the buffered PCS idle blocks, wherein a duration of each substitute data block is substantially the same as a duration of a buffered PCS idle block.

42. The method of claim 40, the method comprising:
identifying plural groups of idle blocks each comprising the predetermined number of PCS idle blocks, and
encoding a number of identified groups of idle blocks as information in the one or more pattern information blocks.

43. The method of claim 36, wherein
the one or more pattern information blocks comprise information indicating a quantity of PCS idle blocks, and/or
the substitute data blocks comprise a plurality of pattern information blocks, each pattern information block comprising information about the PCS idle blocks.

44. The method of claim 36, wherein
monitoring the digital data stream to identify PCS idle blocks comprises identifying sequences of digital bits in the digital data stream having a predetermined pattern of binary states that identify a PCS idle block, and/or
the PCS is an Ethernet PCS.

45. The method of claim 36, wherein the communications system uses an enhanced common public radio interface (eCPRI) protocol, and/or the communications system is an optical link or a microwave link.

46. The method of claim 36, wherein:
the PCS is the top sublayer of a physical layer of the communication system, and/or
the PCS provides an interface between a physical medium attachment (PMA) sublayer of the communications system and a media-independent interface (MII) of the communications system.

47. Transmitter control circuitry of a transmitter in a communications system, the transmitter comprising a physical coding sublayer (PCS) in a communications system for transmitting data to a receiver, the transmitter control circuitry comprising processing circuitry and a non-transitory machine-readable medium storing instructions, wherein the transmitter control circuitry is configured to:
monitor a digital data stream to identify PCS idle blocks in the digital data stream; and
generate substitute data blocks for transmitting to the receiver in place of the PCS idle blocks, the substitute data blocks comprising low transition blocks (LTBs).

48. A method in a physical coding sublayer (PCS) of a communications system of receiving data from a transmitter, the method comprising:
monitoring a digital data stream transmitted from a transmitter to identify one or more pattern information blocks comprising information about PCS idle blocks; and
generating recovered data blocks comprising PCS idle blocks based on the information in the one or more pattern information blocks.

49. The method of claim 48, wherein the method comprises:
generating, based on the information in the one or more pattern information blocks, the recovered data blocks comprising a group of idle blocks comprising a predetermined number of PCS idle blocks, or
generating, based on the information in the one or more pattern information blocks, the recovered data blocks comprising plural groups of idle blocks each comprising a predetermined number of PCS idle blocks.

50. The method of claim 47, wherein
the one or more pattern information blocks comprise information indicating a quantity of PCS idle blocks, and/or
the PCS is an Ethernet PCS.

51. The method of claim 47, wherein the monitoring comprises identifying a plurality of pattern information blocks, each pattern information block comprising information about the PCS idle blocks.

52. The method of claim 47, wherein monitoring the digital data stream to identify the one or more pattern information blocks comprises identifying the information indicating the quantity of PCS idle blocks.

53. The method of claim 47, the method comprising:
receiving the digital data stream from the transmitter, and/or
monitoring the digital data stream to identify a series of digital bits having transitions between binary states as a synchronisation signal.

54. The method of claim 47, wherein
the communications system uses an enhanced common public radio interface (eCPRI) protocol, and/or
the communications system is an optical link or a microwave link.

55. The method of claim 47, wherein:
the PCS is the top sublayer of a physical layer of the communication system, and/or
the PCS provides an interface between a physical medium attachment (PMA) sublayer of the communications system and a media-independent interface (MII) of the communications system.
